(19) United States
(12) Patent Application Publication
(10) Pub. No.: US 2026/0368836 A1
(43) Pub. Date: Nov. 19, 2026

(54) Decentralized Academic Journal System Using Fractionalized Non-Fungible Tokens for Ownership and Dynamic Royalty Distribution

(71) Applicants: Maciej Rysz, Oxford, OH (US); Panayote Pardalos, Gainesville, FL (US); Siddhartha Mehta, Branford, FL (US); Alexander Semenov, Tampa, FL (US)

(72) Inventors: Maciej Rysz, Oxford, OH (US); Panayote Pardalos, Gainesville, FL (US); Siddhartha Mehta, Branford, FL (US); Alexander Semenov, Tampa, FL (US)

(21) Appl. No.: 19/678,723

(22) Filed: May 15, 2026

Related U.S. Application Data
(60) Provisional application No. 63/808,428, filed on May 19, 2025.

(51) Int. Cl. G06Q 50/18; G06Q 40/04; G06Q 50/20

(52) U.S. Cl. CPC G06Q 50/184; G06Q 40/055; G06Q 50/20

(57) ABSTRACT

A computer-implemented decentralized academic journal system integrates a hybrid distributed ledger technology (DLT) layer with peer-reviewed publishing. Upon editor authorization following peer-review approval, an NFT representing the scholarly article is minted. Ownership is fractionalized into fungible tokens (FTs) distributed to multiple stakeholders. A royalty engine dynamically calculates and distributes payments based on citation counts, downloads, and journal revenue data, with off-chain calculations verified on-chain for scalability. A marketplace interface enables secondary FT trading with automatic resale royalty enforcement. The hybrid DLT architecture supports both smart-contract and direct-transaction modes across heterogeneous platforms, providing transparent, usage-based compensation while preserving peer-review integrity.

### CROSS-REFERENCE TO RELATED APPLICATIONS

This application claims the benefit of U.S. Provisional Patent Application No. 63/808,428, filed May 19, 2025, the entire contents of which are incorporated herein by reference.

### BACKGROUND OF THE INVENTION

### Field of the Invention

The present invention relates to computer-implemented systems for academic publishing that integrate distributed ledger technology (DLT) with peer-reviewed workflows to provide automated, transparent ownership and compensation mechanisms.

### Description of Related Art

Conventional academic publishing systems rely on centralized databases and manual processes that cannot automatically track usage metrics or distribute compensation to multiple stakeholders in real time. Existing blockchain-based platforms either lack peer-review integration, use single-owner non-fungible tokens (NFTs) with static royalties, or fail to support fractional ownership across programmable and non-programmable DLT platforms. These limitations result in technical inefficiencies: inability to scale royalty calculations across heterogeneous ledgers, lack of oracle-driven dynamic updates, and no automated secondary-market trading with proportional payouts.

### SUMMARY OF THE INVENTION

The present invention solves the foregoing technical problems by providing a hybrid distributed ledger technology (DLT) architecture that mints a non-fungible token (NFT) for each peer-reviewed scholarly article, fractionalizes ownership into fungible tokens (FTs) distributed among multiple stakeholders, and employs an oracle-integrated royalty engine that dynamically calculates and distributes payments based on real-time usage metrics. The system operates seamlessly on both smart-contract-enabled blockchains and distributed ledger platforms that support direct native token operations without requiring smart contracts (such as Hedera hashgraph), enabling transparent, automated compensation while preserving the integrity of the peer-review process.

Key technical improvements include: (a) peer-review-gated NFT minting via editor authorization following successful peer review; (b) a hybrid DLT layer supporting direct token transfers without smart contracts on all platforms; (c) a royalty engine that records usage based on article access and performs royalty calculations on-chain; and (d) an automated marketplace interface that enforces resale royalties through native DLT transactions.

### BRIEF DESCRIPTION OF THE DRAWINGS

FIG. 1 is a block diagram of the system architecture illustrating the hybrid DLT integration, peer-review module, fractional NFT generator, oracle-driven royalty engine, and marketplace interface.

FIG. 2 is a flowchart of the publishing and tokenization workflow.

FIG. 3 is a flowchart of the dynamic royalty distribution process.

### DETAILED DESCRIPTION OF THE INVENTION

### Technical Problem and Technical Solution

The invention addresses the technical problem of integrating peer-reviewed academic content with distributed ledger systems that must simultaneously support (i) immutable ownership across heterogeneous DLT platforms, (ii) fractional ownership among multiple stakeholders, (iii) real-time usage-based royalty calculations from external data sources, and (iv) automated secondary-market trading—all without disrupting established peer-review workflows.

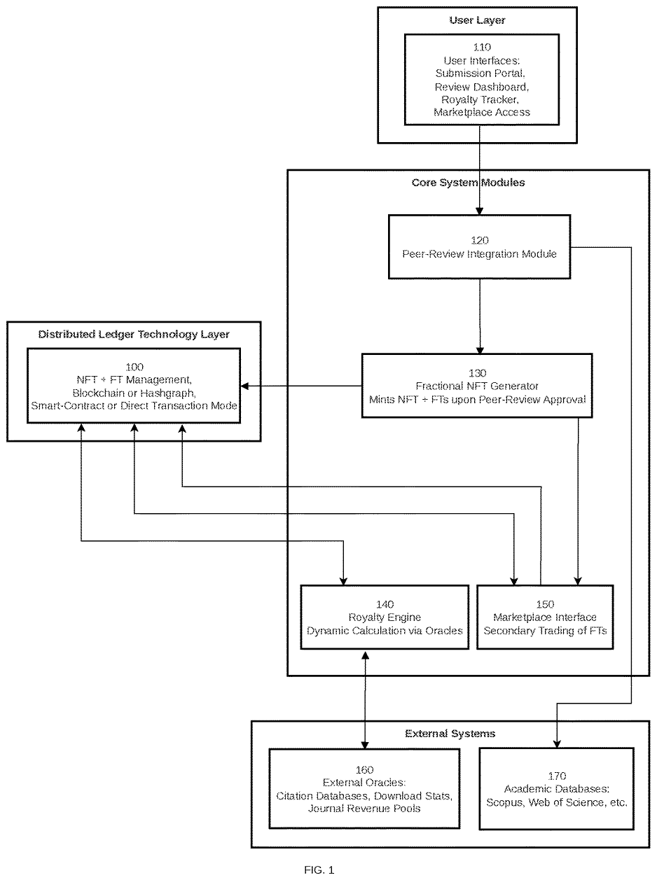

The technical solution is a modular, hybrid DLT architecture (shown in FIG. 1) that operates in two modes: direct DLT token transactions (no smart contracts required) or smart-contract automation. This hybrid capability eliminates the prior-art limitation of platform-specific code while ensuring cryptographic verification of peer-review status before any NFT is minted.

### System Architecture (FIG. 1)

The Distributed Ledger Technology Layer (100) provides immutable record-keeping, NFT and FT creation, ownership transfers, and transaction processing on any DLT supporting tokenization (blockchain or hashgraph).

The Peer-Review Integration Module (120) receives editor authorization following successful peer review and authorizes minting only after the editor approves the article for publication.

The Fractional NFT Generator (130) mints a unique NFT for the accepted article and simultaneously creates and distributes a corresponding set of FTs according to predefined ownership fractions.

The Royalty Engine (140) receives usage metrics (access counts, download statistics, journal revenue pools) recorded manually or via the journal's access tracking system, and performs calculations on-chain (160), performs calculations (optionally off-chain with on-chain verification), and distributes payments proportionally to current FT holders.

The Marketplace Interface (150) enables secondary trading of FTs and automatically triggers resale royalty payments via DLT-native transactions.

User Interfaces (110) and external academic databases (170) complete the system.

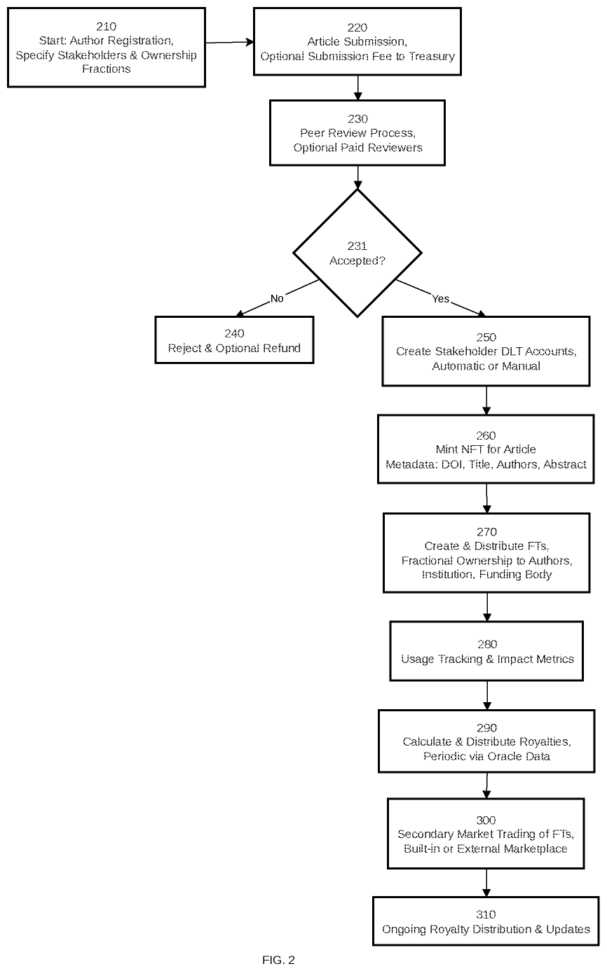

### Publishing and Tokenization Workflow (FIG. 2)

As illustrated in FIG. 2, the submitting author registers (210) and specifies stakeholders and ownership fractions. After submission (220) and successful peer review (230), the system determines whether the article is accepted (231). If rejected, an optional refund is issued (240). Upon acceptance, stakeholder DLT accounts are created (250). An NFT is then minted (260) with embedded metadata. FTs are created and distributed (270) to reflect ownership shares. Usage tracking (280) feeds the royalty engine (290), and FTs may be traded on the secondary marketplace (300). The process continues with ongoing royalty distribution and updates (310).

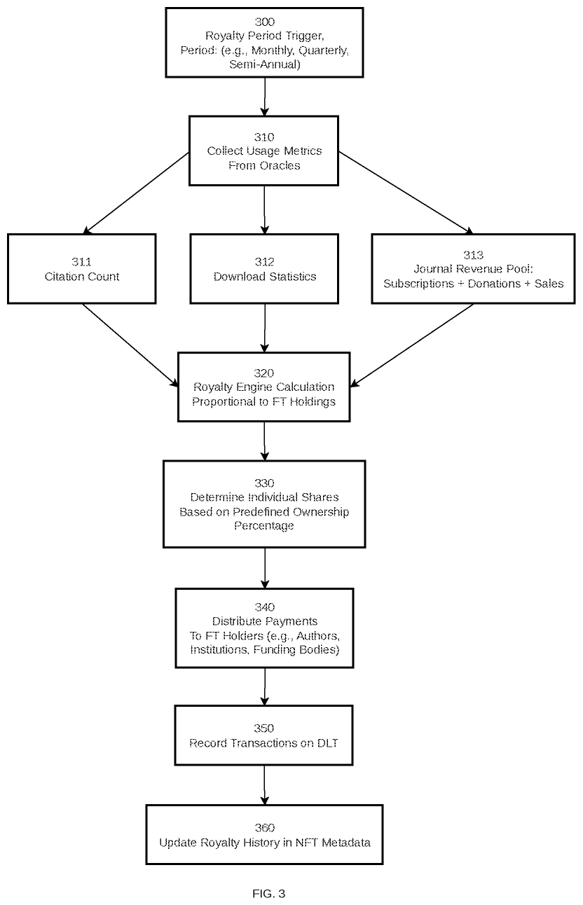

### Dynamic Royalty Distribution (FIG. 3)

Referring to FIG. 3, at each royalty period trigger (300), the engine collects oracle-sourced metrics (311-313), computes proportional shares based on FT holdings (320), distributes payments (340), and records all transactions immutably on the DLT (350). This on-chain verification of off-chain calculations provides both scalability and auditability.

### Example Implementation—Hedera Hashgraph (Direct DLT Mode, no Smart Contracts)

As shown in FIG. 1-3, the following example describes an implementation using the Hedera hashgraph protocol. The following assumptions are made. First, the Hedera network is used as the underlying DLT and functions from Hedera Software Development Kits are employed. Second, the journal has a treasury account that is funded using subscription fees, pay-per-article fees, article submission fees and donations. Third, the journal has created an NFT collection using the TokenCreateTransaction( ) function, from which NFTs will be minted for accepted articles. Fourth, the journal charges an article submission fee. Finally, NFTs for accepted articles are minted using built-in functionality without using a smart contract.

Consider a scenario in which an article written by two authors from the same university is submitted to the journal. The submitting author specifies that the NFT's ownership split should be as follows: 50% to the authors (divided equally) and 50% to their university. Copyright ownership may be retained by the authors or transferred to the journal, depending on the journal's policy. The submission fee (SF) is credited to the journal treasury account, of which a “journal treasury rate (JTF)” (e.g., 20%) is nonrefundable and used to cover operational costs. Upon submission, an appointed journal editor or associate editor makes a preliminary decision. If the paper is rejected at this stage, a refund in the amount of (1−JTF)*SF is issued. Alternatively, the article goes into the peer-review process. To incentivize reviewers, a portion of the funds (1−JTF)*SF are used to compensate them for their services, based on the a priori determined reviewer compensation rate of the journal.

After the review process is complete, the editor makes a final decision. If the article is accepted for publication, accounts on the Hedera network are created for the authors and university using the function accountCreateFcn( ). An NFT is then minted using the function tokenMinterFcn( ), which integrates the article's metadata including: author names, university and department name, article title, abstract, and journal name. Then, 100 FTs specific to the article are created using the function TokenCreateTransaction( ). Each FT represents one percent ownership of the NFT. By calling the function TokenAssociateTransaction( ), the accounts of authors 1 and 2 are each associated with 25 FTs, while 50 FTs are associated with the university account. The FTs are then distributed to each stakeholder's account using the TransferTransaction( ) function. The transactions of minting the NFT, creating and distributing the FTs are automatically recorded on the Hedera network with the calling of the mentioned functions.

A portion of the funds held in the treasury account are designated for royalty payments. Royalties are distributed every six months to stakeholders of the article as follows. Suppose the article was purchased five times and cited 20 times during the six-month period. Then, for example, 70% of the revenue generated from its sales is distributed to the article stakeholders based on their fractional NFT ownership (e.g., each author receives 25% of the royalty, and the university receives 50%). Additionally, let the total cumulative citations of all published articles in the journal for the six-month period be 1000. Then, (20/1000)×100=2% of the subscription fees and donations (or some smaller fraction) generated during the same period are distributed as royalties to the article's stakeholders, proportional to their FT holdings. These royalty calculations may be performed off-chain for computational efficiency, with the results verified and recorded on the Hedera network.

The website that hosts the journal has a native marketplace where FTs can be listed and traded. For instance, if one stakeholder decides to sell their ownership share, they can list their FTs for sale, with the buyers then receiving future royalty distributions. Alternatively, stakeholders may trade FTs on external marketplaces, such as existing Hedera NFT marketplaces, to enhance liquidity and accessibility. (As shown in FIGS. 1-3.)

### Example Implementation—Ethereum (Smart-Contract Mode)

As shown in FIG. 1-3, the following example describes a smart contract-based implementation on the Ethereum blockchain. In this example, the decentralized academic journal system is deployed on the Ethereum blockchain, leveraging its smart contract capabilities to automate and streamline the publishing workflow. The system assumes Ethereum as the underlying DLT, with the journal's treasury managed by a smart contract that handles funds from subscriptions, article fees, submission fees and donations. Articles are represented as ERC-721 NFTs, while fractional ownership is tokenized using ERC-20 FTs. The peer-review process is validated through a decentralized oracle or multi-signature mechanism, and royalties are automatically calculated and distributed based on citation and download metrics provided by external oracles and sales.

For instance, consider a scenario where three researchers from different institutions co-author an article and submit it to the journal. The submitting author specifies the ownership split for the article's NFT as 60% to the authors (20% each) and 40% to a funding body that supported the research. The journal's smart contract governs the entire process, ensuring trustless execution from submission to royalty distribution. The submitting author registers and submits the article via the journal's decentralized application (dApp), paying a submission fee in Ether (ETH), which is locked in the treasury smart contract until the peer-review process concludes. Reviewers, selected by the journal, are compensated from the submission fee upon completing their reviews, as triggered by the smart contract. A multi-signature mechanism, requiring approvals from the editor and at least two reviewers, confirms the article's acceptance. Upon approval, the smart contract mints an ERC-721 NFT for the article, embedding metadata such as the Digital Object Identifier, author names, institution details, and article abstract. Simultaneously, it mints 100 ERC-20 FTs to represent fractional ownership: 20 FTs to each of the three authors (totaling 60) and 40 FTs to the funding body, distributed to their Ethereum wallets. Royalties are distributed quarterly, with an external oracle feeding citation and download data into the smart contract, which calculates payouts using a predefined formula (e.g., 50% based on citations and 50% on downloads). The contract then distributes ETH from the treasury to FT holders proportionally: for example, if the article has 50 citations and 100 downloads with a 10 ETH royalty pool, each stakeholder's share reflects their FT holdings. Stakeholders can trade their FTs on decentralized marketplaces like OpenSea or a custom dApp, with the smart contract enforcing a 5% royalty on each resale, automatically distributed to the original authors and funding body per their initial ownership splits. This implementation automates the publishing process, reduces manual oversight, and ensures transparent, trustless execution, leveraging Ethereum's programmability to adjust royalties dynamically based on real-time academic impact metrics and support a liquid marketplace for fractional ownership. (As shown in FIGS. 1-3.)

### Alternative Embodiments

The system may be implemented fully in smart contracts, on other DLT platforms, with alternative royalty weighting formulas, or under DAO governance, all while retaining the core hybrid architecture and oracle integration.

What is claimed is:

1. A computer-implemented academic publishing system comprising: (a) a fractional non-fungible token (NFT) generator configured to mint, on a distributed ledger technology (DLT) layer, an NFT representing a scholarly article only after only after editor authorization following successful peer-review approval; (b) a royalty distribution engine that receives usage metrics including access counts, download statistics, and journal revenue data recorded by the journal system, and performs calculations on-chain, and automatically distributes payments proportionally to holders of fungible tokens (FTs) that represent fractional ownership shares of the NFT; and (c) a marketplace interface that enables secondary trading of the FTs on the DLT and automatically triggers and distributes resale royalties to the original stakeholders through native DLT transactions, wherein the DLT layer operates in a hybrid mode supporting both direct token-transfer transactions without smart contracts and smart-contract automation on the same platform, thereby solving the technical incompatibility between programmable and non-programmable ledgers while maintaining cryptographic integrity of peer-reviewed content ownership and dynamic compensation.

2. The system of claim 1, wherein the fractional ownership percentages are predefined by the submitting author during registration and recorded in the NFT metadata.

3. The system of claim 1, wherein the royalty distribution engine dynamically recalculates and distributes payments periodically or in real time based on changes in the received usage metrics.

4. The system of claim 1, wherein the marketplace interface automatically deducts a configurable resale royalty percentage and distributes it to the original FT holders via the royalty engine.

5. The system of claim 1, wherein the minted NFT includes embedded metadata comprising at least a Digital Object Identifier (DOI), author names, institution name, article title, and abstract.

6. The system of claim 1, wherein the underlying DLT is configurable to operate across multiple platforms, including blockchain networks and hashgraph networks.

7. The system of claim 1, wherein NFT minting requires editor authorization confirming peer-review approval.

8. The system of claim 1, further comprising an off-chain computation layer that performs royalty calculations and submits verified results to the DLT layer for immutable recording.
